(19) United States
(12) Patent Application Publication
(10) Pub. No.: US 2007/0087292 A1
(43) Pub. Date: Apr. 19, 2007

(54) Color forming compositions

(76) Inventors: Michael J. Day, Philomath, OR (US); Makarand P. Gore, Corvallis, OR (US); Jayprakash C. Bhatt, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,268

(22) Filed: Oct. 13, 2005

(51) Int. Cl. B41M 5/20

(52) U.S. Cl. 430/338; 503/216

(57) ABSTRACT

A color forming composition is provided herein. According to one exemplary embodiment, a color forming composition includes a polymer matrix; an aromatic sulfonylurea activator, a radiation absorber, and an isobenzofuranone color former dye.

### BACKGROUND

Compositions that produce a color change upon exposure to energy in the form of light or heat are of great interest in generating images on a variety of substrates. For example, data storage media provide a convenient way to store large amounts of data in stable and mobile formats. Further, optical discs, such as compact discs (CDs), digital video disks (DVDs), or other discs allow a user to store relatively large amounts of data on a single, relatively small medium. Traditionally, commercial labels were frequently printed onto optical discs by way of screen printing or other similar methods to aid in identification of the contents of the disk.

Current efforts have been directed to providing consumers with the ability to store data on optical disks using drives configured to burn data on recordable compact discs (CD-R), rewritable compact discs (CD-RW), recordable digital video discs (DVD-R), rewritable digital video discs (DVD-RW), and combination drives containing a plurality of different writeable drives, to name a few. The optical disks used as storage mediums frequently have two sides: a data side configured to receive and store data and a label side. The label side is traditionally a background on which the user hand writes information to identify the disc.

Recent developments have provided for the imaging of a dye-containing coating with the lasers of commercially available optical disk drives. However, dyes used in traditional image-able coatings have either had high radiation absorption efficiency and low fade resistance, or low radiation absorption efficiency with high fade resistance and stability.

### SUMMARY

A color forming composition is provided herein. According to one exemplary embodiment, a color forming composition includes a polymer matrix; an aromatic sulfonylurea activator; a radiation absorber, and an isobenzofuranone color former dye.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates a schematic view of a media processing system according to one exemplary embodiment.

FIG. 2 is a flowchart illustrating a method of forming an imageable composition according to one exemplary embodiment.

FIG. 3 is a flowchart illustrating a method for forming a radiation image-able disc according to one exemplary embodiment.

FIG. 4 is a flow chart illustrating a method for forming an image.

Throughout the drawings, identical reference numbers designate similar, but not necessarily identical, elements.

### DETAILED DESCRIPTION

The present exemplary systems and methods provide for the preparation of a single-phase radiation-image-able thermochromic coating for forming multiple colors using a single dye. In particular, a single layer radiation-curable and radiation-imageable coating is described herein that can be imaged with a radiation generating device. According to one exemplary embodiment, the present single-phase radiation image-able coating includes an isobenzofuranone color former dye and an aromatic sulfonyl urea activator dissolved in a UV curable matrix. Further details of the present coating, as well as exemplary methods for forming the coatings on a desired substrate will be described in further detail below.

As used in the present specification, and in the appended claims, the term “radiation image-able discs” is meant to be understood broadly as including, but in no way limited to, audio, video, multi-media, and/or software disks that are machine readable in a CD and/or DVD drive, or the like. Non-limiting examples of radiation image-able disc formats include, writeable, recordable, and rewriteable disks such as DVD, DVD−R, DVD−RW, DVD+R, DVD+RW, DVD-RAM, CD, CD-ROM, CD-R, CD-RW, and the like.

For purposes of the present exemplary systems and methods, the term “color” or “colored” refers to absorbance and reflectance properties that are preferably visible, including properties that result in black, white, or traditional color appearance. In other words, the terms “color” or “colored” includes black, white, and traditional colors, as well as other visual properties, e.g., pearlescence, reflectivity, translucence, transparency, etc.

In the following description, for purposes of explanation, numerous specific details are set forth in order to provide a thorough understanding of the present systems and methods for forming a single phase radiation image-able coating. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

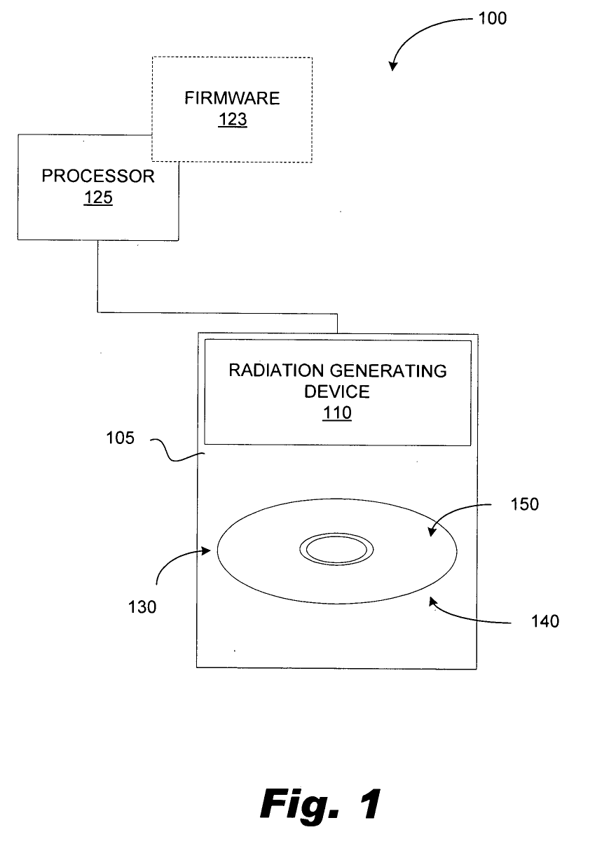

FIG. 1 illustrates a schematic view of a media processing system (100), according to one exemplary embodiment. As will be described in more detail below, the illustrated media processing system (100) allows a user, among other things, to expose a radiation image-able surface with coatings of the present exemplary compositions, register an image on the coatings, and use the imaged object for a variety of purposes. For example, according to one exemplary embodiment, a radiation image-able data storage medium (radiation image-able disc) may be inserted into the media processing system (100) to have data stored and/or a graphic image formed thereon. As used herein, for ease of explanation only, the single phase thermochromic composition will be described in the context of coating an optical disk such as a CD or a DVD. However, it will be understood that the present single phase image-able thermochromic composition may be applied to any number of desired substrates including, but in no way limited to, polymers, papers, metal, glass, ceramics, and the like.

As illustrated in FIG. 1, the media processing system (100) includes a housing (105) that houses a radiation generating device (110), which may be controllably coupled to a processor (125). The operation of the radiation generating device (110) may be controlled by the processor (125) and firmware (123) configured to selectively direct the operation of the radiation generating device. The exemplary media processing system (100) also includes hardware (not shown), such as spindles, motors, and the like, for placing a radiation image-able disc (130) in optical communication with the radiation generating device (110). The operation of the hardware (not shown) may also be controlled by firmware (123) accessible by the processor (125). The above-mentioned components will be described in further detail below.

As illustrated in FIG. 1, the media processing system (100) includes a processor (125) having firmware (123) associated therewith. As shown, the processor (125) and firmware (123) are shown communicatively coupled to the radiation generating device (110), according to one exemplary embodiment. Exemplary processors (125) that may be associated with the present media processing system (100) may include, without limitation, a personal computer (PC), a personal digital assistant (PDA), an MP3 player, or other such device. According to one exemplary embodiment, any suitable processor may be used, including, but in no way limited to a processor configured to reside directly on the media processing system.

Additionally, as graphically shown in FIG. 1, the processor (125) may have firmware (123) such as software or other drivers associated therewith, configured to control the operation of the radiation generating device (110) to selectively apply radiation to the data storage medium (130). According to one exemplary embodiment, the firmware (123) configured to control the operation of the radiation generating device (110) may be stored on a data storage device (not shown) communicatively coupled to the processor (125) including, but in no way limited to, read only memory (ROM), random access memory (RAM), and the like.

As introduced, the processor (125) is configured to controllably interact with the radiation generating device (110). While FIG. 1 illustrates a single radiation generating device (110), any number of radiation generating devices may be incorporated in the media processing system (100). According to one exemplary embodiment, the radiation generating device (110) may include, but is in no way limited to a plurality of lasers configured for forming data on a CD and/or DVD, such as a CD and/or DVD recording drive. Accordingly, the present media processing system (100) may include at least one laser having wavelengths that may vary from between approximately 200 nm to approximately 1200 nm.

As mentioned previously, the present media processing system (100) includes a data storage medium in the form of a radiation image-able disk (130) disposed adjacent to the radiation generating device (110). According to one exemplary embodiment, the exemplary radiation image-able disc (130) includes first (140) and second (150) opposing sides. The first side (140) has a data surface formed thereon configured to store data while the second side (150) includes a radiation image-able surface having a dual band color forming composition.

With respect to the first side (140) of the radiation image-able disk (130), the radiation generating device (110) may be configured to read existing data stored on the radiation image-able disk (130) and/or to store new data on the radiation image-able disc (130), as is well known in the art. As used herein, the term “data” is meant to be understood broadly as including the non-graphic information digitally or otherwise embedded on a radiation image-able disc. According to the present exemplary embodiment, data can include, but is in no way limited to, audio information, video information, photographic information, software information, and the like. Alternatively, the term “data” may also be used herein to describe information such as instructions a computer or other processor may access to form a graphic display on a radiation image-able surface.

In contrast to the first side of the radiation image-able disk (130), the second side of the radiation image-able disk (140) includes a single-phase radiation image-able composition configured to form several colors with a single dye. According to one exemplary embodiment, discussed in further detail below, the second side of the radiation image-able disk (140) includes a single phase that includes an isobenzofuranone dye and an aromatic sulfonyl urea activator. Additionally, the isobenzofuranone dye and aromatic sulfonyl urea activator may be dissolved in a polymer matrix, such as a ultra-violet (UV) curable polymer matrix. Further details of the single-phase radiation image-able composition will be provided below.

As mentioned above, the second side of the radiation image-able disk (140) includes a number of components forming a single phase configured to be imaged by one or more radiation sources. According to one exemplary embodiment, the present coating formulation includes, but is in no way limited to, a radiation-curable polymer matrix with an isobenzofuranone dye and an aromatic sulfonyl urea activator dissolved therein. Several exemplary formulations will be described in detail below.

Exemplary Method of Forming a Color Forming Composition

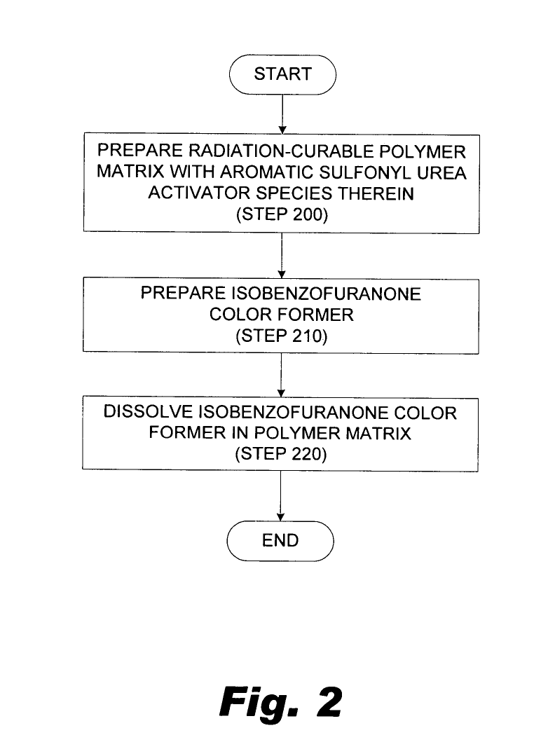

FIG. 2 is a flowchart illustrating an exemplary method of forming a radiation image-able thermochromic composition. In general, a method of forming the image-able thermochromic composition includes preparing the radiation-curable polymer matrix with an aromatic sulfonylurea activator species dissolved therein (step 200), preparing an isobenzofuranone dye (step 210), and dissolving the isobenzofuranone dye in the radiation-curable polymer matrix (step 220).

As introduced, the first step of the exemplary method includes preparing a matrix material, such as a UV-curable matrix, having an aromatic sulfonyl urea activator dissolved therein (step 200). Additionally, a number of activators may be dissolved in the present radiation curable polymer matrix. According to one exemplary embodiment, the activators present in the radiation curable polymer matrix may include an aromatic sulfonylurea activator. Suitable activators for use with the present exemplary system and method include, but are in no way limited to, compounds such as, benzenesulfonamide, 4-methyl-N-[[[3-[[(4-methylphenyl)sulfonyl]oxy]phenyl]amino]carbonyl]-(9Cl), N-p-Tolylsulfonyl-N′-3-(p-tolylsulfonyloxy)phenylurea, commercially known as Pergafast 201. In particular, according to one exemplary method, an aromatic sulfonyl urea such as Pergafast 201 is mixed with a UV-curable matrix to a concentration of between about 5 to about 50, such to a concentration of about 36%. Further, according to such an exemplary embodiment, the UV-curable matrix includes an infrared dye at a concentration of between about 0.05 to about 2%, such as a concentration of about 0.85%. Other suitable activators, may be used in combination, include, without limitation, Benzenesulfonamide, N,N′-[methylenebis(4,1-phenyleneiminocarbonyl)] 4,4′-Bis(p-toluenesulfonylaminocarbonylamino) diphenylmethane; 4,4′-Bis(p-toluenesulfonylaminocarboxylamino)diphenylmethane; 4,4′-Bis(p-tolylsulfonylureido)diphenylmethane; BTUM N-(p-toluenesulfonyl)-N′-(3-p-toluenesulfonyl-oxy-phenyl)urea, 4,4′-bis[(4-methyl-3-phenoxycarbonylaminophenyl)ureido]diphenyl sulfone, a color developer, R1 urea deriv. R1SO2NHCONHC(:X)NHCOR2 (R1, R2=arom. group which may be substituted for R1 selected from lower alkyls and halos; X═O, S), 4,4′-bis[(4-methyl-3-phenoxycarbonylaminophenyl)ureido]diphenyl sulfone, 4,4′-bis(N-p-tolylsulfonylaminocarbonylamino)diphenylmethane, N-p-tolylsulfonyl-N′-3-(p-tolylsulfonyloxy)phenyl urea, 4,4′-bis[(4-methyl-3-phenoxycarbonylaminophenyl)ureido]diphenyl sulfone, 2,2-bis[4-(4-methyl-3-phenylureidophenyl)aminocarbonyloxyphenyl]propane, and 4-(p-tolylsulfonylamino)phenol.

According to one exemplary embodiment, the radiation curable polymer, in the form of monomers or oligomers, may be a lacquer configured to form a continuous phase, referred to herein as a matrix phase, when exposed to light having a specific wavelength. More specifically, according to one exemplary embodiment, the radiation curable polymer may include, by way of example, UV-curable matrices such as acrylate derivatives, oligomers, and monomers, with a photo package. A photo package may include a light absorbing species, such as photoinitiators, which initiate reactions for curing of the lacquer, such as, by way of example, benzophenone derivatives. Other examples of photoinitiators for free radical polymerization monomers and oligomers include, but are not limited to, thioxanethone derivatives, anthraquinone derivatives, acetophenones, benzoine ethers, and the like.

According to one exemplary embodiment, the radiation-curable polymer matrix phase may be chosen such that curing is initiated by a form of radiation that does not cause a color change of the color-former present in the composition, according to the present exemplary system and method. For example, the radiation-curable polymer matrix may be chosen such that the above-mentioned photo package initiates reactions for curing of the lacquer when exposed to a light having a different wavelength than that of the color former dye. Matrices based on cationic polymerization resins may require photoinitiators based on aromatic diazonium salts, aromatic halonium salts, aromatic sulfonium salts, and metallocene compounds. A suitable lacquer or matrix may also include Nor-Cote CLCDG-1250A (a mixture of UV curable acrylate monomers and oligomers), which contains a photoinitiator (hydroxyl ketone) and organic solvent acrylates, such as methyl methacrylate, hexyl methacrylate, beta-phenoxy ethyl acrylate, and hexamethylenediol diacrylate. Other suitable components for lacquers or matrices may include, but are not limited to, acrylated polyester oligomers, such as CN293 and CN294 as well as CN-292 (low viscosity polyester acrylate oligomer), trimethylolpropane triacrylate commercially known as SR-351, isodecyl acrylate commercially known as SR-395, and 2(2-ethoxyethoxy) ethyl acrylate commercially known as SR-256, all of which are commercially available from Sartomer Co.

According to one exemplary embodiment, the present radiation imageable composition includes one or more antenna uniformly distributed/dissolved in the composition. The examples of antennae are-indolium compounds which can be used are available from Aldrich Chemical Company, and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene) ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof. Alternatively, the radiation antenna can be an inorganic compound, e.g., ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used in the present system and method. Suitable pyrimidinetrione-cyclopentylidene infrared antennae include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9Cl) (S0322 available from Few Chemicals, Germany).

Further, the radiation antenna can be selected for optimization of the color forming composition in a wavelength range from about 600 nm to about 720 nm, such as about 650 nm. Non-limiting examples of suitable radiation antennae for use in this range of wavelengths can include indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium,1-butyl-2-[5-(1-butyl-1,3-dihydro-3,3-dimethyl-2H-indol-2-ylidene)-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λmax=645 nm). Phthalocyanine dyes having a λmax of about the desired development wavelength can also be used such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, Jul. 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having a λmax=806 nm).

Laser light having blue and indigo wavelengths from about 300 nm to about 600 nm can be used to develop the color forming compositions. Therefore, color forming compositions may be selected for use in devices that emit wavelengths within this range. Recently developed commercial lasers found in certain DVD and laser disk recording equipment provide for energy at a wavelength of about 405 nm. Thus, the compositions discussed herein using appropriate radiation antennae can be suited for use with components that are already available on the market or are readily modified to accomplish imaging. Radiation antennae which can be useful for optimization in the blue (˜405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λmax=400 nm); ethyl 7-diethylaminocoumarin-3-carboxylate (λmax=418 nm); 3,3′-diethylthiacyanine ethylsulfate (λmax=424 nm); 3-allyl-5-(3-ethyl-4-methyl-2-thiazolinylidene) rhodanine (λmax=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH.

Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Methyl Yellow (CAS 60-11-7), 4-phenylazoaniline (CAS 60-09-3), Alcian Yellow (CAS 61968-76-1), available from Aldrich chemical company, and mixtures thereof.

According to one exemplary embodiment, the media processing system (100; FIG. 1) may include a radiation generating device configured to produce one or more lasers with wavelength values of 300 nm to approximately 780 nm. By matching the wavelength values of the radiation generating device(s) (110; FIG. 1), image formation is maximized. Exemplary methods of forming the above-mentioned composition, as well as methods for forming images on the composition are described in further detail below.

Returning to FIG. 2, the present method also includes the preparation of an isobenzofuranone color former (step 210). Suitable isobenzofuranone color former dyes may include, but are in no way limited to, 1(3H )-Isobenzofuranone, 4,5,6,7-tetrachloro-3,3-bis[2-(4-methoxyphenyl)-2-[4-(1-pyrrolidinyl)phenyl]ethenyl]-(9Cl), 3,3-Bis[1-(4-methoxyphenyl)-1-(4-pyrrolidinophenyl)ethylen-2-yl]-4,5,6,7-tetrachlorophthalide; 3,3-Bis[1-(4-methoxyphenyl)-1-(4-pyrrolidinophenyl)ethylene-2-yl]-4,5,6,7-tetrachlorophthalide1(3H)-Isobenzofuranone, 4,5,6,7-tetrachloro-3,3-bis[2-(4-ethoxyphenyl)-2-(4-methoxyphenyl)ethenyl]-(9Cl) 1(3H)-Isobenzofuranone, 4,5,6,7-tetrachloro-3,3-bis[2-[4-(dimethylamino)phenyl]-2-(4-methoxyphenyl)ethenyl]-(9Cl), 3,3-Bis[1-(4-methoxyphenyl)-1-(4-dimethylaminophenyl)ethylen-2-yl]-4,5,6,7-tetrachlorophthalide; 3,3-Bis[2-(4-dimethylaminophenyl)-2-(4-methoxyphenyl)ethenyl]-4,5,6,7-tetrachlorophthalide; 3,3-Bis[2-(4-dimethylaminophenyl)-2-(4-methoxyphenyl)vinyl]-4,5,6,7-tetrachlorophthalide known commercially as NIR black. Other suitable color former dyes include, dyes described in Chemistry and Applications of Leuco Dyes, Muthyala, Ramaiha, ed.; Plenum Press, New York, London; ISBN: 0-306-45459-9, which is incorporated herein by reference

Further, according to one exemplary embodiment, preparation of the isobenzofuranone color former dye includes the addition of a number of melting aids that may be included with the above-mentioned color former. As used herein, the melting aids may include, but are in no way limited to, crystalline organic solids with melting temperatures in the range of approximately 50° C. to approximately 150° C., and preferably having a melting temperature in the range of about 70° C. to about 120° C. In addition to aiding in the dissolution of the isobenzofuranone dye and the antenna dye, the above-mentioned melting aid may also assist in reducing the melting temperature of the isobenzofuranone dye and stabilize the isobenzofuranone dye alloy in the amorphous state, or slow down the re-crystallization of the isobenzofuranone-dye alloy into individual components. Suitable melting aids include, but are in no way limited to, aromatic hydrocarbons (or their derivatives) that provide good solvent characteristics for isobenzofuranone-dye and antenna dyes used in the present exemplary systems and methods. By way of example, suitable melting aids for use in the current exemplary systems and methods include, but are not limited to, m-terphenyl, pbenzyl biphenyl, alpha-naphtol benzylether, 1,2[bis(3,4]dimethylphenyl)ethane. In some embodiments, the percent of color-former and melting aid can be adjusted to minimize the melting temperature of the color-former phase without interfering with the development properties of the leuco dye. When used, the melting aid can comprise from approximately 1 wt % to approximately 10 wt % of the color forming composition.

The prepared isobenzofuranone color former dye is then added to the polymer matrix. In particular, according to one exemplary embodiment, the isobenzofuranone color former is added to the UV curable matrix until a color former concentration of between about 5% to about 50% is achieved. In a more preferred embodiment the color former has a concentration of between about 30 to about 40%. As previously discussed, the aromatic sulfonyl urea activator is also dissolved in the matrix phase. Consequently, the isobenzofuranone-dye and the activator component of the matrix phase are contained in a single phase, thus forming a complete, single-phase radiation image-able composition. Such a coating may be applied to media, as will now be discussed in more detail. Upon heating with laser radiation, the activator causes the color former to sequentially change color when subjected to radiation for longer periods.

Method of Forming a Radiation Image-Able Disc

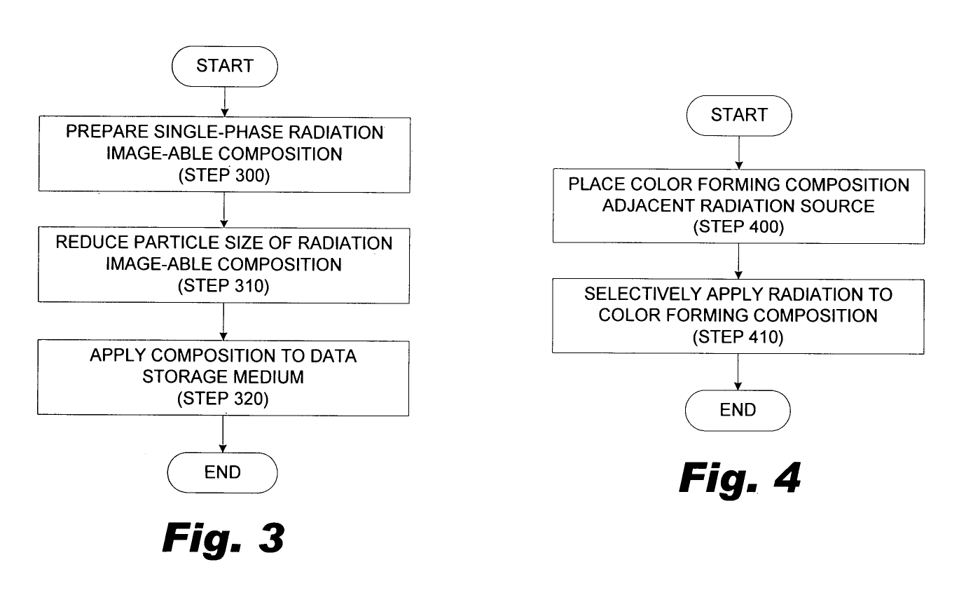

FIG. 3 illustrates a method of forming a radiation image-able disc according to one exemplary embodiment. The method begins by preparing a single-phase radiation image-able coating that includes an isobenzofuranone color former dye and an aromatic sulfonylurea activator dissolved in a polymer matrix (step 300). According to one exemplary method, the single-phase radiation imageable coating may be formed as discussed above.

The particle size of the single-phase radiation image-able coating is then reduced (step 310). For example, according to one exemplary embodiment, the single-phase radiation image-able coating is subjected to a milling operation. In particular, the single-phase radiation image-able coating may pass through a three-roll milling machine until a desired particle size or consistency is achieved. Such three-roll milling operation may include about 10 passes through the three-roll milling machine.

The single-phase radiation image-able coating may then be applied to a substrate, such as a media storage disc (step 320). In particular, according to one exemplary method, the processed single phase radiation image-able coating may then be applied to the substrate by a screen printing operation with a 7 μm mesh and then using ultra-violet light to cure the coating. Such a coating may be slightly opaque or transparent. Such an appearance may indicate that the activate ingredients are dispersed/dissolved in the coating. Thus, the present exemplary method provides for the formation of a disc with a single-phase radiation image-able coating applied thereto. Radiation may then be selectively applied to the radiation image-able coating to form images thereon.

Method of Forming an Image

FIG. 4 illustrates a method of forming an image on a radiation image-able disc. The method begins by placing the radiation image-able disc adjacent a radiation generating device with the radiation image-able coating in optical communication with the radiation generating device (step 400). With the radiation image-able coating in optical communication with the radiation generating device (step 400), the radiation image-able coating may then be selectively exposed to radiation from the radiation generating device to form the desired image (step 410).

In particular, when subjected to radiation, the activator causes the radiation image-able composition to first turn black. Continued application of radiation causes the black to fade to cyan and then to magenta, and from magenta to yellow. Thus, the color of a given area of the radiation image-able disc may be controlled by controlling the application of radiation in that region.

The present exemplary systems and methods provide for the preparation of a single-phase radiation-image-able thermochromic coating for forming multiple colors using a single dye. In particular, a single layer radiation-curable and radiation-imageable coating is described herein that can be imaged with a radiation generating device. According to one exemplary embodiment, the present single-phase radiation image-able coating includes an isobenzofuranone color former dye and an aromatic sulfonyl urea activator dissolved in a UV curable matrix. Further details of the present coating, as well as exemplary methods for forming the coatings on a desired substrate will be described in further detail below.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

1. A color forming composition, comprising:
a polymer matrix;
an activator comprising aromatic sulfonylurea;
a radiation antenna, and
an isobenzofuranone color former;
wherein said antenna renders said color forming composition reactive to form colors when exposed to radiation of a specific wavelength.

2. The composition of claim 1, wherein said activator and color former are at least partially dissolved in said polymer matrix to form a single phase.

3. The composition of claim 1, wherein said activator comprises at least one of benzenesulfonamide, 4-methyl-N-[[[3-[[(4-methylphenyl)sulfonyl]oxy]phenyl]amino]carbonyl]-(9Cl), or N-p-Tolylsulfonyl-N′-3-(p-tolylsulfonyloxy)phenylurea.

4. The composition of claim 1, wherein said polymer matrix comprises a UV curable matrix.

5. The composition of claim 1, wherein said activator is present in a concentration of between about 5% to about 50%.

6. The composition of claim 5, wherein said activator is present in a concentration of between about 30% to about 40%.

7. The composition of claim 1, wherein said activator includes an infrared dye.

8. The composition of claim 7, wherein said infrared dye is present in concentration of between about 0.05% to about 2%.

9. The composition of claim 8, wherein said infrared dye is present in concentration of about 0.85%.

10. The composition of claim 1, wherein said activator includes at least one of benzenesulfonamide, N,N′-[methylenebis(4,1-phenyleneiminocarbonyl)]4,4′-Bis(p-toluenesulfonylaminocarbonylamino) diphenylmethane; 4,4′-Bis(p toluenesulfonylaminocarboxylamino)diphenylmethane; 4,4′-Bis(p-tolylsulfonylureido)diphenylmethane; BTUM N-(p-toluenesulfonyl)-N′-(3-p-toluenesulfonyl-oxy-phenyl)urea, 4,4′-bis[(4-methyl-3-phenoxycarbonylaminophenyl)ureido]diphenyl sulfone, a color developer, R1 urea deriv, R1SO2NHCONHC(:X)NHCOR2 (R1, R2=arom, group which may be substituted for R1 selected from lower alkyls and halos; X═O, S), 4,4′-bis[(4-methyl-3-phenoxycarbonylaminophenyl)ureido]diphenyl sulfone, 4,4′-bis(N-p-tolylsulfonylaminocarbonylamino)diphenylmethane, N-p-tolylsulfonyl-N′-3-(p-tolylsulfonyloxy)phenyl urea, 4,4′-bis[(4-methyl-3-phenoxycarbonylaminophenyl)ureido]diphenyl sulfone, 2,2-bis[4-(-methyl-3-phenylureidophenyl)aminocarbonyloxyphenyl]propane, or 4-(p-tolylsulfonylamino)phenol.

11. The composition of claim 1, wherein said isobenzofuranone color former dye includes at least one of 1(3H)-isobenzofuranone, 4,5,6,7-tetrachloro-3,3-bis[2-(4-methoxyphenyl)-2-[4-(1-pyrrolidinyl)phenyl]ethenyl]-(9Cl), 3,3-bis[1-(4-methoxyphenyl)-1-(4-pyrrolidinophenyl)ethylen-2-yl]-4,5,6,7-tetrachlorophthalide; 3,3-Bis[1-(4-methoxyphenyl)-1-(4-pyrrolidinophenyl)ethylene-2-yl]-4,5,6,7-tetrachlorophthalide1(3H)-Isobenzofuranone, 4,5,6,7-tetrachloro-3,3-bis[2-(4-ethoxyphenyl)-2-(4-methoxyphenyl)ethenyl]-(9Cl) 1(3H)-Isobenzofuranone, 4,5,6,7-tetrachloro-3,3-bis[2-[4-(dimethylamino)phenyl]-2-(4-methoxyphenyl)ethenyl]-(9Cl), 3,3-bis[1-(4-methoxyphenyl)-1-(4-dimethylaminophenyl)ethylen-2-yl]-4,5,6,7-tetrachlorophthalide; 3,3-bis[2-(4-dimethylaminophenyl)-2-(4-methoxyphenyl)ethenyl]4,5,6,7-tetrachlorophthalide; or 3,3-bis[2-(4-dimethylaminophenyl)-2-(4-methoxyphenyl)vinyl]4,5,6,7-tetrachlorophthalide.

12. The composition of claim 1, further comprising a melting aid.

13. The composition of claim 12, wherein said melting aid is present in a concentration of between about 1% to about 10%.

14. The composition of claim 1, wherein said isobenzofuranone color former is present in a concentration of about 5% to about 50%.

15. The composition of claim 14, wherein said isobenzofuranone color former is present in a concentration of between about 30% to about 40%.

16. A method of forming a color-forming composition for labeling an optical disc, comprising:
preparing a radiation-curable polymer matrix;
dissolving an aromatic sulfonyl urea activator species m said radiation-curable matrix;
dissolving an isobenzofuranone color former in said radiation-curable matrix; and
forming a layer of said matrix comprising said activator and color former on an optical disc.

17. The method of claim 16, wherein dissolving said aromatic sulfonyl urea activator species includes adding said activator to achieve a concentration of between about 5% to about 50%.

18. The method of claim 17, wherein dissolving said aromatic sulfonyl urea activator species includes adding said activator to achieve a concentration of between about 30% to about 40%.

19. The method of claim 16, wherein dissolving said aromatic sulfonyl urea includes dissolving an infrared dye to achieve a concentration of between about 0.05% to about 2%.

20. The method of claim 19, wherein said infrared dye is dissolved to a concentration of about 0.85%.

21. The method of claim 16, wherein said isobenzofuranone color former is dissolved to achieve a concentration of about 5% to about 50%.

22. The composition of claim 21, wherein said isobenzofuranone color former is dissolved to a concentration of between about 30% to about 40%.

23. A method of forming an image, comprising:
selectively applying electromagnetic radiation to a color forming composition sufficient to develop irradiation portions of the color forming composition from a pre-development state to a post-development state that is visually different than the pre-development state, wherein a color of said post-development state depends on an amount of time a portion of said composition was exposed to said radiation, said color forming composition including a polymer matrix having an isobenzofuranone color former and an aromatic sulfonyl urea activator dissolved in said polymer matrix, said composition further including a radiation antenna wherein said antenna renders said color forming composition reactive to form colors when exposed to radiation at specific wavelengths.

24. A method as in claim 23, wherein the electromagnetic radiation is applied for a duration and at an energy level such that the color forming composition does not decompose.

25. The method of claim 23, wherein said electromagnetic radiation is laser energy.

26. The method of claim 23, wherein said electromagnetic radiation is applied at from about 0.05 J/cm² to about 5 J/cm².

27. The method of claim 23, wherein said electromagnetic radiation is applied for about 15 μsec to about 200 μsec.

28. The method of claim 23, wherein said electromagnetic radiation is applied at a spot size from about 10 μm to about 60 μm.

29. The method of claim 23, wherein said electromagnetic radiation is applied at a power level from about 15 mW and about 100 mW.

30. The method of claim 23, wherein said electromagnetic radiation has a wavelength from about 200 nm to about 1200 nm.

31. The method of claim 23, further comprising a preliminary step of applying said color forming composition to a substrate.

32. The method of claim 31, wherein said substrate includes an optical disk.

33. The composition of claim 1, wherein said antenna comprises an inorganic compound.

34. The composition of claim 1, wherein said antenna comprises an inindolium compound.

35. The composition of claim 1, wherein said antenna comprises at least one of a polymethine dye or derivative thereof, an indocyanine dye, or a phthalocyanine dye.

36. The composition of claim 1, wherein said specific wavelength corresponds to a wavelength of a laser of an optical disc drive.

37. The composition of claim 1, where said specific wavelength is in a range from about 600 nm to about 720 nm.

38. The composition of claim 12, wherein said melting aid comprises an aromatic hydrocarbon.
